(19) United States
(12) Patent Application Publication
(10) Pub. No.: US 2006/0191762 A1
(43) Pub. Date: Aug. 31, 2006

(54) Low drag multimode clutch

(76) Inventor: Mark A. Joki, Dover, OH (US)

Correspondence Address: MICHAEL BEST & FRIEDRICH, LLP, 100 E WISCONSIN AVENUE, MILWAUKEE, WI, 53202, US

(21) Appl. No.: 10/552,002

(22) PCT Filed: Feb. 22, 2005
(86) PCT No.: PCT/US05/05562

§ 371 Date: Oct. 4, 2005

Related U.S. Application Data
(60) Provisional application No. 60/546,854, filed on Feb. 23, 2004.

(51) Int. Cl. B60K 23/08

(52) U.S. Cl. 192/38

(57) ABSTRACT

A clutch device comprising a first member, a second member, a race member, and a slipper member. The first member (12) has a first sonic surface and the second member (3) has a second conic surface (6) generally opposed to the first conic surface. The race member (13) is fixed to the first conic surface of said first member and the slipper (11)is positioned adjacent the second conic surface of the second member. The race and the slipper members have complementary projections (20, 22) to define pockets into which rollers (14) are arranged. The axial relationship of the first and second members is adjustable to control mating between the slipper (11) and the second conic surface (6) of the second member and thereby enable or prevent torque transmission between the first and second members.

### BACKGROUND

The present invention relates to a clutch device. More particularly, the present invention relates to a multimode clutch device.

Planetary gear automatic transmissions employ one-way clutches to simplify shifting. If a first planetary stage is transmitting power through a one-way clutch, a parallel connected second stage with a higher ratio can be engaged during a shift. The one-way clutch allows the output speed to increase without the first stage resisting the increased speed. The first planetary stage is however incapable of carrying negative torque because of the one-way clutch. If the one-way clutch can be selectively locked, additional ratios can be designed into the transmission without adding additional planetary stages. U.S. Pat. No. 6,409,001 discloses a full complement multimode clutch that is capable of providing selectable one-way forward, one-way reverse, freewheeling, and locking modes. This clutch relies on a ‘slipper’ ring which must rub against a mating surface to provide a lockup. The present invention avoids the frictional losses of the slipper clutch in a freewheeling mode while still allowing mode control.

### SUMMARY

The present invention provides a clutch device comprising a first member, a second member, a race member, and a slipper member. The first member has a first conic surface and the second member has a second conic surface generally opposed to the first conic surface. The race member is fixed to the first conic surface of said first member and the slipper member is positioned adjacent the second conic surface of the second member. The race member has multiple longitudinal projections corresponding to similar projections on the slipper member to define pockets into which rollers are arranged. The slipper member has a surface matable with the second conic surface of said second member. The axial relationship of the first and second members is adjustable to control mating between the slipper member and the second conic surface of the second member and thereby enable or prevent torque transmission between the first and second members.

In at least one embodiment, the second member is a portion of a planet carrier of a planetary gear stage.

In a preferred embodiment of the present invention, the axial relationship between the first and second members is biased by spring force to prevent engagement and hydraulic actuation is utilized to overcome the spring force to cause engagement.

### BRIEF DESCRIPTION OF THE DRAWINGS

FIG. 1 is a sectional view of a planetary reduction stage employing a device according to a first embodiment of the invention.

FIG. 2 is a sectional view of the slipper clutch components of FIG. 1.

FIGS. 3a-c are sectional views of the assembly steps of a preferred method of assembling the device according to the first embodiment of the invention.

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

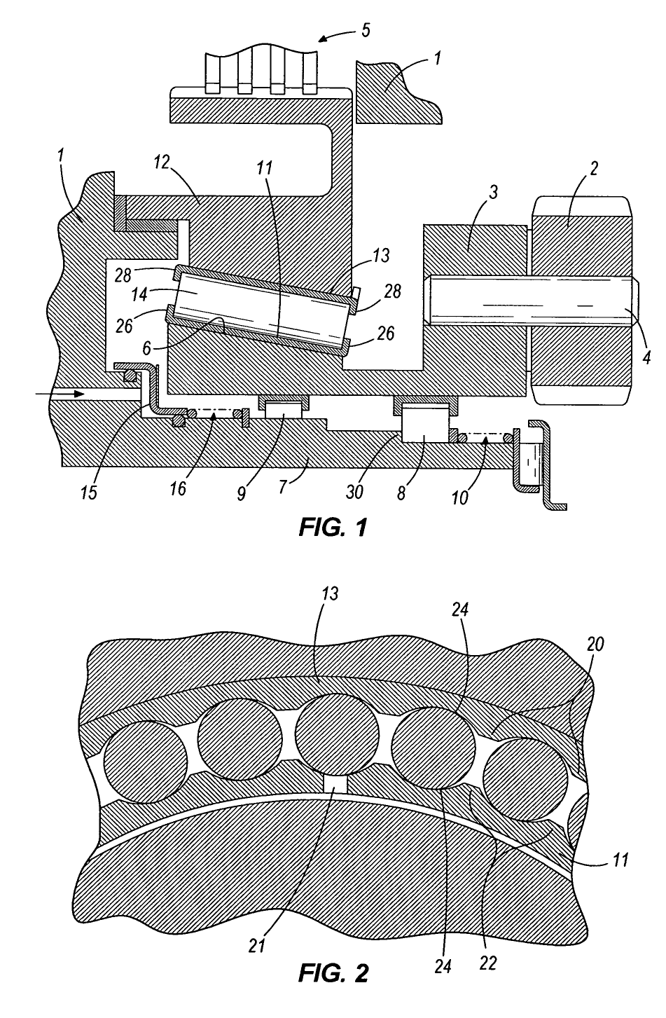

Referring to FIG. 1, a planetary reduction stage within a housing 1 comprises a multiplicity of planet gears 2 supported by planet carrier 3 by way of support pins 4 and engaged to a sun gear and ring gear (not shown). The planet carrier 3 is rotatably supported by bearings 8 and 9. Onto the planet carrier 3 is formed a conic outer peripheral surface 6 which preferably has a shallow angle. The angle is preferably in the range of 1-3 degrees, preferably 1.5 degrees, but can be of an angle less than 1 degree or greater than 3 degrees. Radially outward from the conic surface 6 is an outer body 12 rotatably supported in the housing 1 by bearing surfaces in the housing 1. Said outer body 12 includes a conic inner peripheral surface of angle similar to surface 6 onto which is fixed a ring shaped clutch outer race 13. A ring shaped slipper 11 is located radially inward from the outer race 13. While the preferred embodiment is described with the ring shaped clutch race fixed to the outer body 12 conic surface with the slipper positioned radially inward, it is also considered that the components may be reversed, with the ring shaped clutch race fixed to the conic surface 6 and the slipper positioned radially outward.

Referring to FIG. 2, on the inner periphery of the outer race 13 and into the outer periphery of the slipper 11 are formed longitudinal projections 20, 22 radially opposing each other. These projections 20, 22 form pockets 24 into which cylindrical rollers 14 are placed. The slipper 11 has an opening 21 cut parallel to the slipper's 11 axis to facilitate radial contraction. The slipper 11 is manufactured to a diameter slightly larger than its mounted size to apply a radial preload force to the rollers 14. The outer race 13 and slipper 11 are generally uniform in section along a longitudinal section. Referring back to FIG. 1, the outer race 13 and slipper 11 have flanges 26, 28 formed at the extremes of their widths to contain the rollers 14.

The axial location of the planet carrier 3, in its free state, is determined by roller bearing 8 which is located by a shoulder 30 in a generally cylindrical projection from the housing 7 and a spring 10. In this free state, the slipper 11 is free of the conic outer surface 6 with a small clearance, about 40-80 microns, allowing low drag rotation of the planet carrier 3. A plate clutch 5 can cause torque transmission between the outer body 12 and the housing, 1. When such torque transmission is desired, hydraulic pressure is applied to the left side of piston 15, moving it against retraction spring 16 until it contacts the planet carrier 3 and moves the planet carrier 3 right against spring 10. The slipper 11 now rubs against the conic surface 6. The tangential force carried through the rollers 14 causes them to climb the sides of their pockets 24, contracting the slipper opening 21 until the slipper 11 stops against the conic surface 6. When the clearance is removed, the rollers 14 are contacting the races at a pressure angle of 83 to 88 degrees which causes locking of the slipper 11 on the conic surface 6 and a high torque transmission capability.

To accomplish an upshift, the pressure on the piston 15 is removed, causing the piston 15 to retract under force from spring 16. However, because of the high forces of the slipper 11 on the conic surface 6, the planet carrier 3 remains in the engaged position. A clutch elsewhere in the transmission applies torque to a higher gear stage causing a reduction in torque to the subject planet stage with the slipper clutch. As torque reaches zero, the contracting force from the rollers 14 on the slipper 11 disappears, and the slipper 11 expands under its prestress. With the slipper contact relieved, the planet carrier 3 moves away from the slipper 11 by force from spring 10 and the low drag freewheeling mode is active.

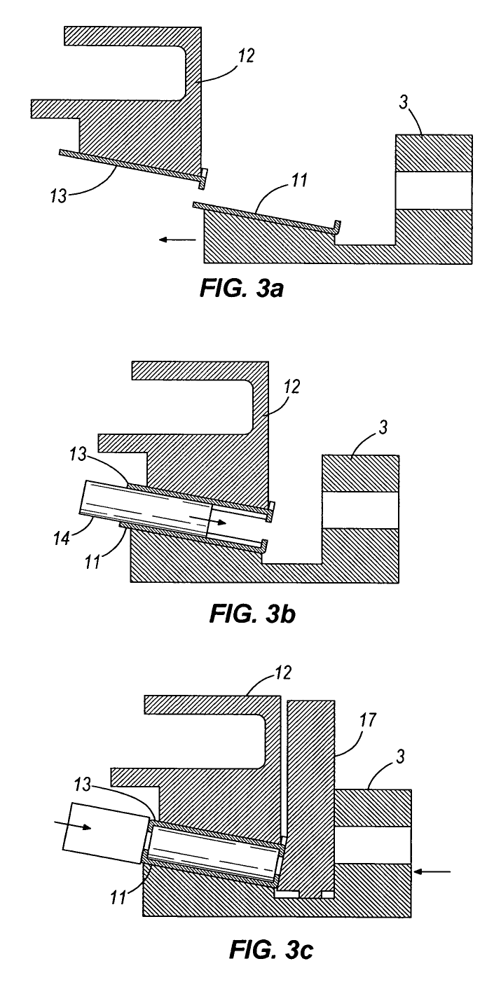

Referring to FIGS. 3a-c, a preferred method of assembly is shown. Referring to FIG. 3a, the device is assembled by first installing the outer race 13 into the outer body 12 and the slipper 11 over the conic surface 6, then placing the outer body 12 around the slipper 11. Referring to FIG. 3b, the rollers 14 are placed between the outer race 13 and the slipper 11. Referring to FIG. 3c, a split disk tool 17 is placed in the axial gap between the outer body 12 and the planet carrier 3 to resist the force of crimping the ends of the slipper 11 and the outer race 13, thereby restraining the rollers 14.

What is claimed is:

1. A clutch device comprising:
a first member having a first conic surface;
a second member concentric with the first member and having a second conic surface generally axially aligned with the first conic surface;
a race member fixed to the first conic surface; and
a slipper member positioned adjacent to the second conic surface in opposed relation to the race member, the race and slipper members having complementary projections to define pockets into which rollers are arranged,
wherein the first and second members are axially adjustable relative to one another between a first axial relationship in which the slipper is free of the second conic surface and a second axial relationship in which the slipper contacts the second conic surface.

2. The clutch device according to claim 1 wherein the first member is radially outward relative to the second member.

3. The clutch device according to claim 1 wherein the first member is radially inward relative to the second member.

4. The clutch device according to claim 1 wherein the second member is a portion of a planet carrier of a planetary gear stage.

5. The clutch device according to claim 1 wherein the first and second conic surfaces are each at angle in the range of 1 to 3 degrees.

6. The clutch device according to claim 5 wherein the first and second conic surfaces are each at angle of 1.5 degrees.

7. The clutch device according to claim 1 wherein the slipper member has an axial opening therethrough such that the slipper member is expandable or contractible.

8. The clutch device according to claim 7 wherein in the second axial relationship, the rollers are caused to climb the projections and thereby cause the slipper member to expand or contract into a fixed relationship with the second member second conic surface.

9. The clutch device according to claim 8 wherein in the second axial relationship, the rollers contact the projections at a pressure angle between 83 to 88 degrees.

10. The clutch device according to claim 1 wherein the slipper member is configured to apply a prestress against the rollers.

11. The clutch device according to claim 1 wherein the race member and slipper member each have axial edges provided with radial flanges to retain the rollers within the pockets.

12. The clutch device according to claim 1 wherein a spring biases one of the first or second members to the first axial relationship.

13. The clutch device according to claim 12 further comprising a fluid pressure source configured to selectively apply a fluid pressure force against the spring bias to move the first and second members in to the second axial relationship.

14. The clutch device according to claim 1 wherein in the first axial relationship a clearance in the range of 40-80 microns is provided between the slipper member and the second conic surface.

15. A method of forming a clutching device comprising the steps of:
providing a first member having a first conic surface;
fixing a race member to the first conic surface, the race member having a plurality of projections thereon and having a first axial end with a radially extending flange and a generally open second axial end;
providing a second member having a second conic surface;
providing a slipper member adjacent the second conic surface, the slipper member having a plurality of projections thereon and having a first axial end with a radially extending flange and a generally open second axial end;
positioning the first member relative to the second member such that the race member is opposed to the slipper member and the race and slipper member projections define pockets;
positioning rollers in to the pockets; and
closing the race member second axial end and the slipper member second axial end to retain the rollers within the pockets.

16. The method according to claim 15 wherein the step of closing the race member second axial end and the slipper member second axial end includes providing a split disk tool adjacent to the race member first axial end and the slipper member first axial end.

17. The method according to claim 16 wherein the step of closing the race member second axial end and the slipper member second axial end includes crimping the race member second axial end and the slipper member second axial end.
